(19) United States
(12) Patent Application Publication
(10) Pub. No.: US 2016/0285394 A1
(43) Pub. Date: Sep. 29, 2016

(54) OPENING/CLOSING BODY CONTROL DEVICE AND OPENING/CLOSING BODY CONTROL METHOD

(71) Applicants: Kazutaka Kubota, Aichi (JP); Keigo Fujimoto, Aichi (JP)

(72) Inventors: Kazutaka Kubota, Aichi (JP); Keigo Fujimoto, Aichi (JP)

(73) Assignee: OMRON AUTOMOTIVE ELECTRONICS CO., LTD., Aichi (JP)

(21) Appl. No.: 15/046,503

(22) Filed: Feb. 18, 2016

(30) Foreign Application Priority Data
Mar. 26, 2015 (JP) 2015-064896

(51) Int. Cl. H02P 3/06; H02P 29/00

(52) U.S. Cl. CPC H02P 3/06; H02P 29/00

(57) ABSTRACT

An opening/closing body control device controls opening or closing of an opening/closing body with an electric motor. The opening/closing body control device includes: a bridge circuit which includes a switching element connected to the electric motor; and a control unit which controls an on or off state of the switching element. The control unit controls the on or off state of the switching element such that the bridge circuit enters a regenerative state in a case where control for fully closing or fully opening the opening/closing body is performed. The control unit controls the on or off state of the switching element such that the bridge circuit does not enter the regenerative state in a case where an operation of the opening/closing body is performed by a person.

### CROSS-REFERENCES TO RELATED APPLICATIONS

This application is based upon and claims the benefit of priority from Japanese Patent Application No. 2015-064896, filed on Mar. 26, 2015, the entire contents of which are incorporated herein by reference.

### FIELD

One or more embodiments of the present invention relate to a control device and a control method for an opening/closing body which can electrically be opened and closed.

### BACKGROUND

A technique in which a bridge circuit is provided to perform control of driving and regenerative braking for an electric opening/closing body is hitherto known. For example, JP-A-2008-005656 discloses a vehicular automatic opening/closing device which increases regenerative braking force of an electric motor to increase followability to a target speed of an opening/closing body. In the vehicular automatic opening/closing device, an electric motor which drives and opens or closes a sliding door is connected to an H bridge circuit, driving control and regenerative braking control of the electric motor are performed with the H bridge circuit, and pulse width modulation (PWM) control is performed on a switching element of the H bridge circuit to perform speed control of the sliding door so as to match a target speed. When the opening/closing speed of the sliding door is faster than the target speed, regenerative braking of the electric motor is performed, a carrier frequency of a PWM signal is set to be lower than when driving the electric motor, a duty ratio is increased, or the like, and regenerative braking force of the electric motor is improved (for equivalent techniques, see JP-A-2008-184740 and JP-A-H10-246061).

JP-A-2013-174077 discloses an opening/closing body control device which prevents rapid movement of an opening/closing body in an operation state where a manual operation is possible. The opening/closing body control device includes a door opening/closing control device, a sliding door, and a door opening/closing motor which drives the sliding door, supplies power to the door opening/closing motor at the time of driving the sliding door, and cuts off power supplied to the door opening/closing motor at the time of stopping the sliding door. Then, the opening/closing body control device includes a motor control circuit which controls the door opening/closing motor, and a brake control circuit which applies braking to the door opening/closing motor using regenerative power generated due to the operation of the sliding door when power to the door opening/closing motor is cut off by the motor control circuit.

JP-A-2011-236697 discloses a power assist door which provides a comfortable operation feeling. The power assist door is a power assist door which detects the movement of the door, assists the movement of the door in the moving direction with power of a motor, and adjusts the power feed amount to the motor based on a current flowing in the motor and a change in door moving speed. The power assist door performs stationary control for maintaining the power feed amount to the motor when a change in speed is within a range of a speed change threshold, sets a first current value threshold and a second current value threshold, which increases in an ascending order, with respect to a current value, performs acceleration control when the current value is smaller than the first current value threshold, and performs deceleration control when the current value is greater than the second current value threshold.

JP-A-2012-107387 discloses a power assist door which provides a comfortable operation feeling. The power assist door is a power assist door which assists the movement of the door with power of a motor, and has detection means provided near a door handle to detect a movement operation of the door, and a control unit which performs initial movement control for applying a given voltage to the motor if the movement operation of the door is detected by the detection means in a state where the door is stopped in a full close state or a full open state, and performs normal control for adjusting the power feed amount to the motor based on a current flowing in the motor.

JP-A-2004-027824 discloses an operation system for an in-vehicle door which automatically opens or closes the door, and prevents an unexpected operation, for example, in a case where the weight of the door is increased due to snow or the like. The operation system intermittently operates the drive mechanism to execute a braking operation in a case where a back door falls after the door is switched from a state of being automatically operated by the drive mechanism to a driving release state where a manual operation is possible.

### SUMMARY

One or more embodiments of the invention provides an opening/closing body control device which optimizes driving control and regenerative braking control of an opening/closing body according to whether or not an operation of an electric opening/closing body is performed by a person and improves user-friendliness.

In order to solve the above-described problems, according to one or more embodiments of the invention, an opening/closing body control device which controls opening or closing of an opening/closing body with an electric motor includes a bridge circuit which includes a switching element connected to the electric motor, and a control unit which controls the on or off state of the switching element. The control unit controls the on or off state of the switching element such that the bridge circuit enters a regenerative state in a case where control for fully closing or fully opening the opening/closing body is performed, and the control unit controls the on or off state of the switching element such that the bridge circuit does not enter the regenerative state in a case where an operation of the opening/closing body is performed by a person.

With the above configuration, the switching element is controlled to enter the regenerative state in a case where control for fully closing or fully opening the opening/closing body is performed, and the switching element is controlled not to enter the regenerative state in a case where an operation of the opening/closing body is performed by a person, whereby it is possible to provide an opening/closing body control device which optimizes driving control and regenerative braking control of an opening/closing body according to whether or not an operation of the electric opening/closing body is performed by a person and improves user-friendliness.

Further, in one or more embodiments of the invention, in the above opening/closing body control device, a case where the control unit performs control for fully closing or fully opening the opening/closing body may be a case where the control unit controls a speed for fully closing or fully opening the opening/closing body.

With the above configuration, the switching element is controlled to enter the regenerative state in a case where the speed for fully closing or fully opening the opening/closing body is controlled, whereby it is possible to further optimize driving control and regenerative braking control of the opening/closing body in a case where an operation of the opening/closing body is performed by a person and to improve user-friendliness.

In order to solve the above-described problems, according to one or more embodiments of the invention, an opening/closing body control method which controls opening or closing of an opening/closing body with an electric motor includes performing driving control and regenerative braking control in a case where control for fully closing or fully opening the opening/closing body is performed, and inhibiting the regenerative braking control in a case where an operation of the opening/closing body is performed by a person.

With the above configuration, driving control and regenerative braking control are performed in a case where control for fully closing or fully opening the opening/closing body is performed, and regenerative braking control is not performed in a case where an operation of the opening/closing body is performed by a person, whereby it is possible to provide an opening/closing body control method which optimizes driving control and regenerative braking control of an opening/closing body according to whether or not an operation of the electric opening/closing body is performed by a person and improves user-friendliness.

As described above, according to one or more embodiments of the invention, it is possible to provide an opening/closing body control device and an opening/closing body control method which optimize driving control and regenerative braking control of an opening/closing body according to whether or not an operation of an electric opening/closing body is performed by a person and improve user-friendliness.

### BRIEF DESCRIPTION OF THE DRAWINGS

FIG. 1 is a circuit diagram of an opening/closing body control device according to an embodiment of the invention;

FIG. 2 is a flowchart showing a control method in the opening/closing body control device according to the embodiment of the invention;

FIG. 3A is an explanatory circuit diagram for driving control of a first drive mode in the opening/closing body control device according to the embodiment of the invention;

FIG. 3B is an explanatory circuit diagram for regenerative braking control of the first drive mode in the opening/closing body control device according to the embodiment of the invention;

FIG. 3C is an explanatory circuit diagram for driving control of a second drive mode in the opening/closing body control device according to the embodiment of the invention;

FIG. 3D is an explanatory circuit diagram for control other than driving control of the second drive mode in the opening/closing body control device according to the embodiment of the invention;

FIG. 4A is a control chart of the first drive mode in the opening/closing body control device according to the embodiment of the invention;

FIG. 4B is a control chart of the second drive mode in the opening/closing body control device according to the embodiment of the invention; and

FIG. 5A is an explanatory view showing the relationship between a target speed and an actual speed in the first drive mode in the opening/closing body control device according to the embodiment of the invention, and FIG. 5B is an explanatory view showing the relationship between a target current and an actual current in the second drive mode in the opening/closing body control device according to the embodiment of the invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, an embodiment of the invention will be described referring to the drawings.

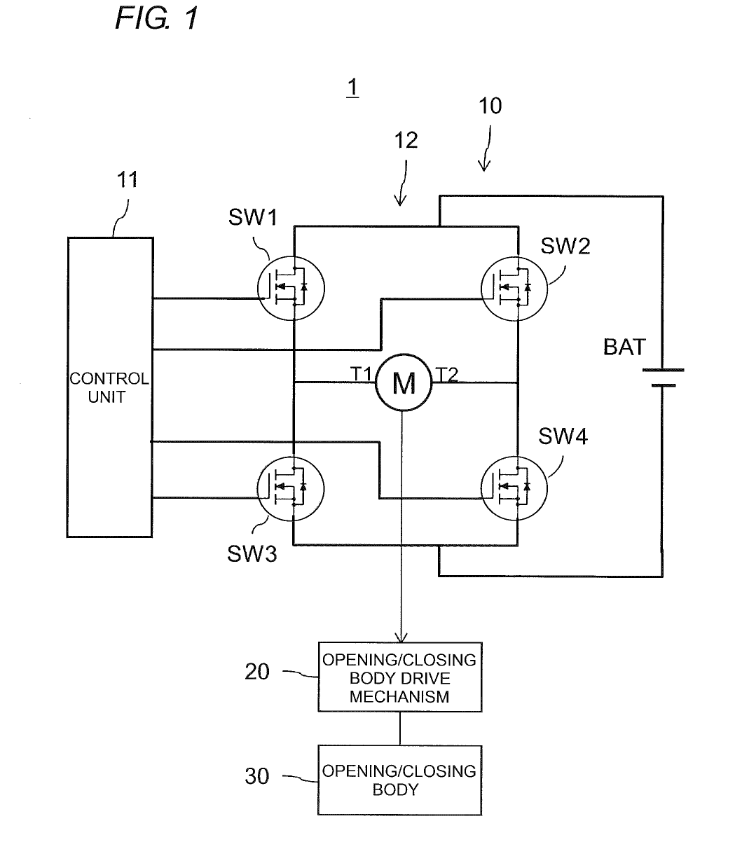

An opening/closing body control device 10 in this embodiment will be described referring to FIG. 1. The opening/closing body control device 10 includes a bridge circuit 12 which is connected to an electric motor M, and a control unit 11 which is connected to the bridge circuit 12 and controls the bridge circuit 12.

The bridge circuit 12 includes four switching elements SW1 to SW4 which are respectively field effect transistors (FET). The bridge circuit 12 includes a first switching element SW1 for normal rotation which has one end connected to one terminal T1 of the electric motor M and the other end connected to a positive electrode of a power supply BAT, a second switching element SW4 for normal rotation which has one end connected to the other terminal T2 of the electric motor M and the other end connected to a negative electrode of the power supply BAT, a first switching element SW2 for reverse rotation which has one end connected to the other terminal T2 of the electric motor M and the other end connected to the positive electrode of the power supply BAT, and a second switching element SW3 for reverse rotation which has one end connected to one terminal T1 of the electric motor M and the other end connected to the negative electrode of the power supply BAT. That is, the bridge circuit 12 has a configuration in which the four switching elements SW1 to SW4 are bridge-connected to the electric motor M.

The electric motor M is a power source of an opening/closing body drive mechanism 20 which automatically opens or closes an opening/closing body 30, such as a sliding door of a side portion or a power tail gate of a rear portion in a vehicle 1. In the electric motor M, in order to drive the opening/closing body 30 in both opening and closing directions, as described below, the rotation direction is switched between normal rotation and reverse rotation, and the rotation speed is controlled through PWM control. The opening/closing body drive mechanism 20 refers to a mechanical mechanism which is driven by the electric motor M and is required to open or close the opening/closing body 30.

The control unit 11 switches (turns on or off) the four switching elements SW1 to SW4 to a conduction state or a cutoff state in a predetermined combination, thereby controlling the rotation direction (normal rotation and reverse rotation) and the rotation speed of the electric motor M. For example, the two switching elements SW1 and SW4 for normal rotation are turned on, and the two switching elements SW2 and SW3 for reverse rotation are turned off, whereby a current can flow between both terminals of the electric motor M through the switching elements SW1 and SW4 to normally rotate the electric motor M. Conversely, the two switching elements SW2 and SW3 for reverse rotation are turned on, and the two switching elements SW1 and SW4 for normal rotation are turned off, whereby a current opposite to normal rotation can flow between the terminals to reversely rotate the electric motor M.

The second switching element SW4 for normal rotation and the second switching element SW3 for reverse rotation, or the first switching element SW1 for normal rotation and the first switching element SW2 for reverse rotation are turned on, whereby both terminals of the electric motor M can be short-circuited through the switching elements to perform regenerative braking of the electric motor M.

For the switching elements SW1 to SW4, usually, semiconductor switches, such as field effect transistors (FETs), are used. For the control unit 11, as control means, a microcomputer including a central processing unit (CPU), a driver IC, a memory, and the like is used. The memory stores a control method for normal rotation and a control method for reverse rotation of the switching elements SW1 to SW4, and a control method of controlling the rotation speed of the electric motor M, that is, the opening/closing speed of the opening/closing body 30, in detail, a control method described below. The control unit 11 sends control signals to the respective switching elements SW1 to SW4 according to these control methods, and drives the switching elements SW1 to SW4 in a predetermined combination.

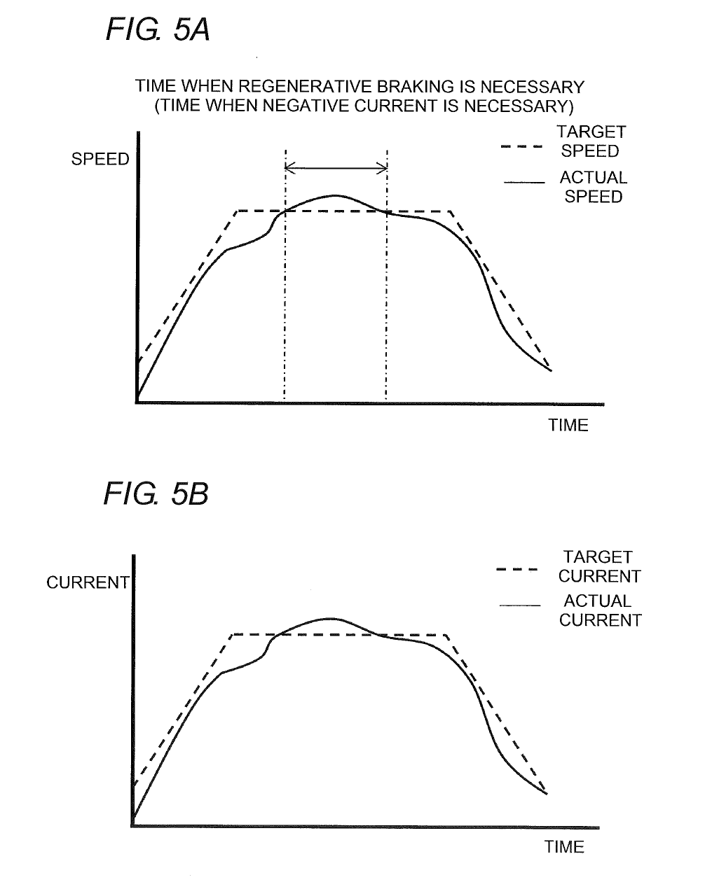

The control unit 11 performs driving control and regenerative braking control of the electric motor M using the bridge circuit 12. The control unit 11 performs pulse width modulation (PWM) control of the switching elements SW1 to SW4 of the bridge circuit 12 to perform speed control such that the driving speed of the opening/closing body 30, such as a sliding door or a power tail gate, matches a target speed. As shown in FIG. 5A, usually, a sliding door or the like is controlled to become slower near a full open position and a full close position and faster at an intermediate position. The control unit 11 appropriately performs driving control and regenerative braking control while performing PWM control such that the opening/closing body 30 follows the target speed (dotted line) to be controlled, and performs control such that an actual speed (solid line) is as close to the target speed (dotted line) as possible.

For example, the control unit 11 performs driving control by performing PWM control while changing (increasing) the duty ratio such that the opening/closing body 30 first starts to be opened (normally rotates) at a slow speed and gradually increases in speed in a case of switching the opening/closing body 30 from the full close position to the full open position. The control unit 11 has a target speed which is determined in advance to reach a constant speed at an intermediate position and performs driving control of the electric motor M with a constant duty ratio. However, the control unit 11 performs regenerative braking control of the electric motor M in a case where the opening speed of the opening/closing body 30 is faster than the target speed (a time zone indicated by an arrow in this drawing), performs PWM control even in this case, and performs control such that the opening speed of the opening/closing body 30 follows the target speed. Driving control is performed by performing PWM control while changing (decreasing) the duty ratio such that a speed of normal rotation gradually becomes slow if the opening/closing body 30 approaches the full open position. The same control is reversely performed in a case where the opening/closing body 30 is switched from the full open position to the full close position.

In the embodiment of the invention, in a case where a closing operation or an opening operation of the opening/closing body 30 by the user is detected, as shown in FIG. 5B, even in a case where the opening speed of the opening/closing body 30 is faster than the target speed, regenerative braking control is not performed on the electric motor M. As a result, regenerative braking which acts in a direction of canceling a force of an operation of the user is avoided, and the closing operation or the opening operation of the electric motor M is controlled to assist the closing operation or the opening operation of the user.

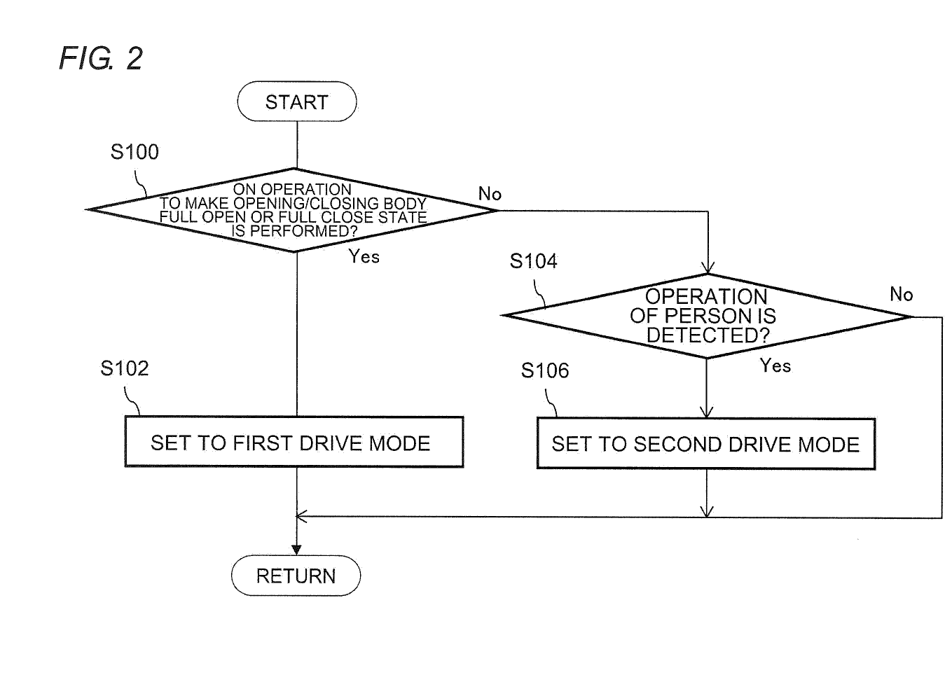

A control method of the control unit 11 of the opening/closing body control device 10 will be described referring to FIG. 2. Note that S in the flowchart means a step. In S100, the control unit 11 continues to monitor that a user of the vehicle 1 performs or has performed an operation to fully open or fully close the opening/closing body 30 with a remote control or the like for use in opening or closing the opening/closing body 30 of the vehicle 1 (ON operation). In a case where it is detected that the ON operation has been performed, that is, in a case where control for fully closing or fully opening the opening/closing body 30 is performed, in S102, the control unit 11 sets a drive mode to a first drive mode in which regenerative braking described below is performed.

In a case where it is detected that the ON operation is not performed, in S104, the control unit 11 monitors whether or not the closing operation or the opening operation of the opening/closing body 30 by the user is detected. For example, the control unit 11 monitors whether or not the user performs the closing operation or the opening operation such that the closing operation or the opening operation is performed in a state where the opening/closing body 30 is stopped. Monitoring is performed based on the presence or absence of an output value from a sensor which detects the rotation of the electric motor and the rotation direction of the output value. In a case where it is detected that the operation of the opening/closing body 30 is performed by the user, in S106, the control unit 11 sets the drive mode to a second drive mode in which regenerative braking described below is not performed. In a case where it is not detected that the operation of the opening/closing body 30 is performed by the user, the control unit 11 does not do any particular thing.

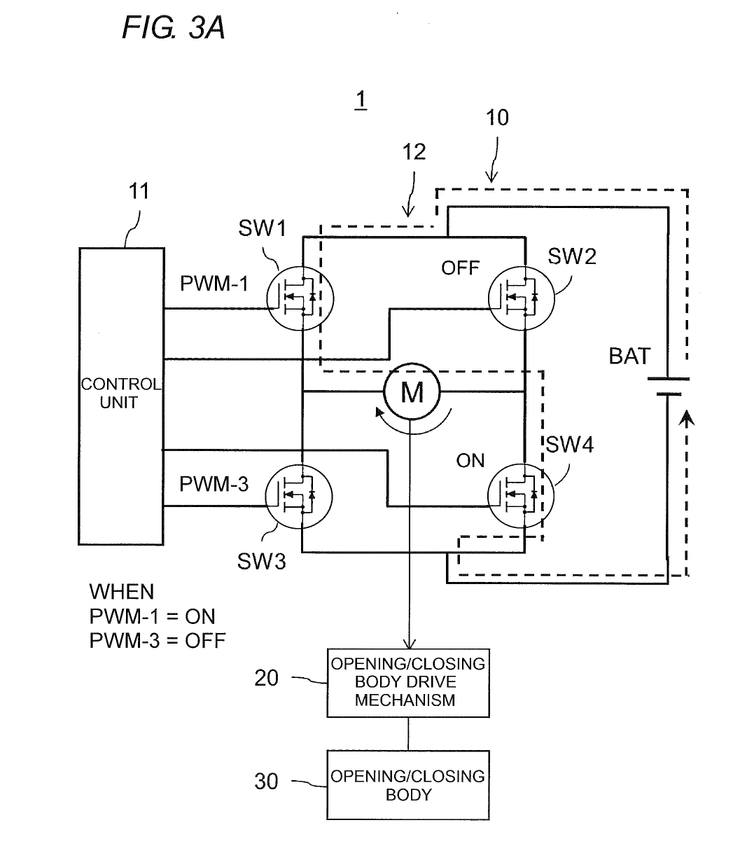

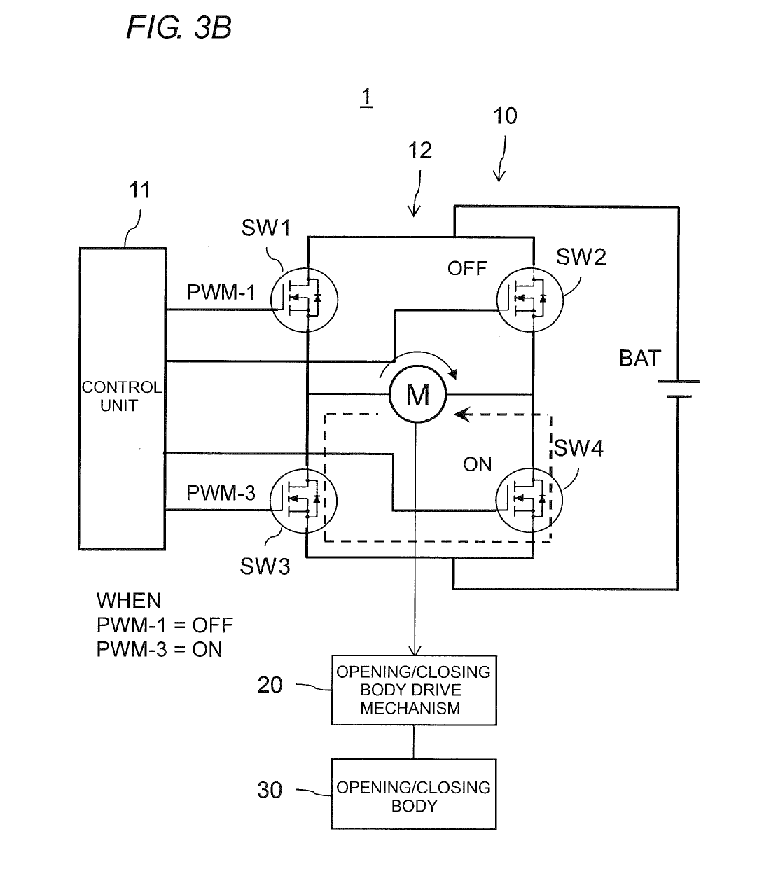

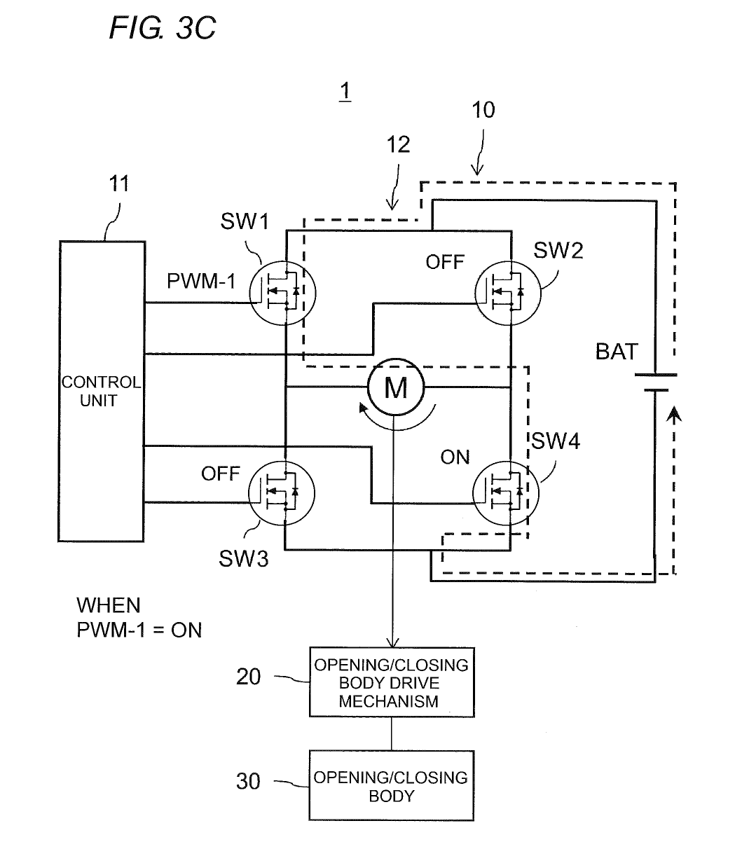

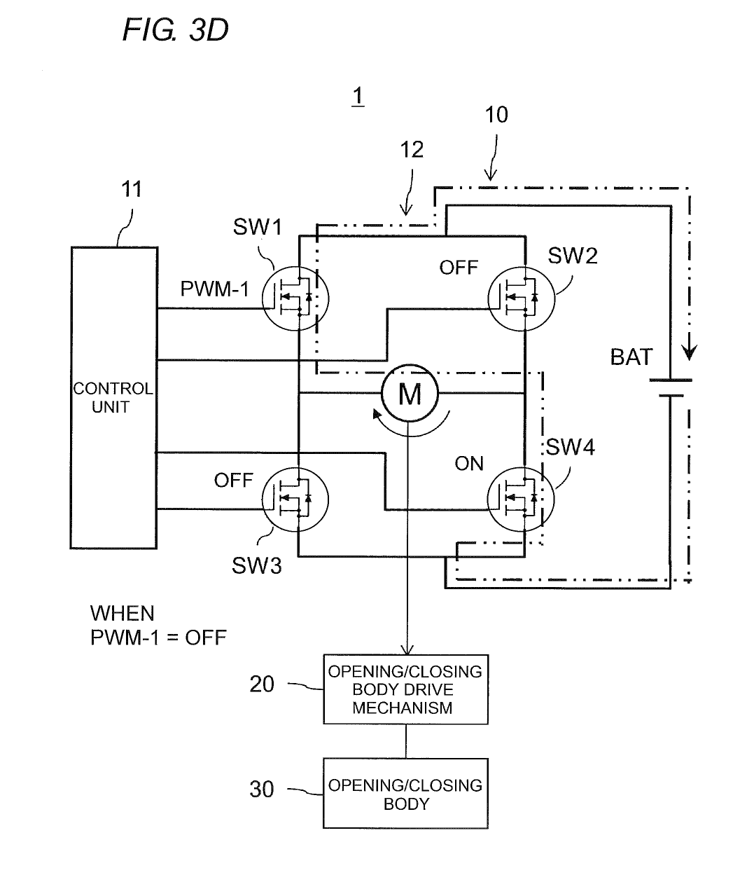

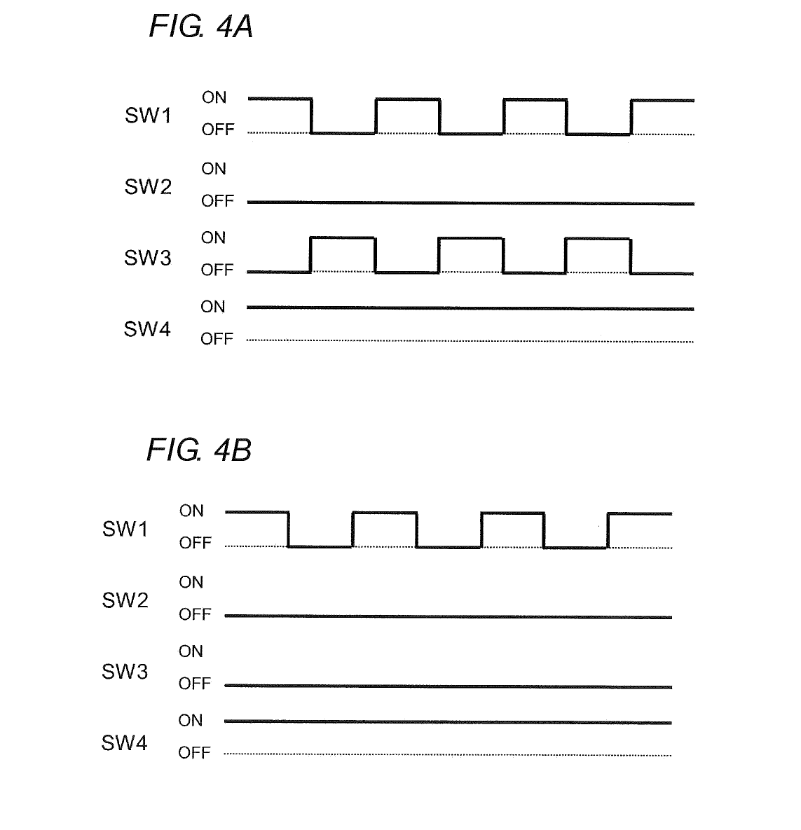

A more detailed control method of the control unit 11 will be described referring to FIGS. 3A to 3D, and 4A and 4B. FIGS. 3A, 3B, and 4A are diagrams illustrating the first drive mode, and FIGS. 3C, 3D, and 4B are diagrams illustrating the second drive mode.

In the first drive mode, the respective switching elements are controlled as follows. The switching elements SW1 and SW3 are subjected to PWM driving control. During the control, when the switching element SW1 is ON, the switching element SW3 is OFF. Conversely, when the switching element SW1 is OFF, the switching element SW3 is ON. The switching element SW2 is controlled to always be in the OFF state. The switching element SW4 is controlled to always be in the ON state.

In FIG. 3A, in order to normally rotate the electric motor M, the control unit 11 causes the switching element SW1 of the bridge circuit 12 to enter a state (PWM-1) where PWM control is performed and the switching element SW4 to enter the ON state. Furthermore, in order to reversely rotate the electric motor M, the control unit 11 causes the switching element SW2 to enter the OFF state and the switching element SW3 to enter a state (PWM-3) where PWM control is performed. This drawing shows when the switching element SW1 is ON (PWM-1=ON) and the switching element SW3 is OFF (PWM-3=OFF) in the PWM control. Then, a current indicated by a dotted line flows in the bridge circuit 12 to normally rotate (arrow direction) the electric motor M, and the control unit 11 controls the rotation speed of the electric motor M, that is, the opening speed of the opening/closing body 30 according to the duty ratio with respect to the switching element SW1.

FIG. 3B shows a regenerative state in the first drive mode in which regenerative braking described referring to FIG. 5A is performed. In the regenerative state, the control unit 11 turns the switching element SW1 OFF (PWM-1=OFF) and the switching element SW3 ON (PWM-3=ON) according to the normal rotation (arrow direction) of the electric motor M while performing PWM control. At this time, a current opposite to normal rotation indicated by a dotted line flows in the bridge circuit 12, and the control unit 11 performs regenerative braking control to decrease the rotation speed of the electric motor M, that is, the opening speed of the opening/closing body 30 according to the duty ratio with respect to the switching element SW3.

FIG. 4A is a control chart of the switching elements SW1 to SW4 in the first drive mode in a case where the duty ratio is about 0.5. As described above, the switching elements SW1 and SW3 are subjected to PWM control and are alternately and repeatedly ON and OFF, the switching element SW2 is always OFF, and the switching element SW4 is always ON. The duty ratio of 0.5 is for illustration, and control is performed such that the duty ratio of the switching element SW1 is increased in a case where the electric motor M is driven with normal rotation, and such that the duty ratio of the switching element SW3 is increased in a case where regenerative braking of the electric motor M is performed. At the time of regenerative braking, the path in the bridge circuit 12 is short, impedance is made small, and a negative current easily flows to allow braking to be easily applied, power consumption is small, and heat generation is also small.

In the second drive mode, the respective switching elements are controlled as follows. The switching element SW1 is subjected to PWM driving control. Then, the switching element SW2 is controlled to always be in the OFF state. The switching element SW3 is controlled to always be in the OFF state. The switching element SW4 is controlled to always be in the ON state.

In FIG. 3C, the control unit 11 causes the switching element SW1 of the bridge circuit 12 for normally rotating the electric motor M to enter a state (PWM-1) where PWM control is performed, the switching element SW4 to enter the ON state, and the switching elements SW2 and SW3 to enter the OFF state. This drawing shows when the switching element SW1 is ON (PWM-1=ON) in the PWM control. Then, a current indicated by a dotted line flows in the bridge circuit 12 to normally rotate (arrow direction) the electric motor M, and the control unit 11 controls the rotation speed of the electric motor M, that is, the opening speed of the opening/closing body 30 according to the duty ratio with respect to the switching element SW1.

FIG. 3D shows the state of the second drive mode in which regenerative braking described referring to FIG. 5B is not performed. At this time, the switching element SW1 is in the OFF state. Since there is a parasitic diode in the switching element SW1, it is assumed that a current flows in an opposite direction even when the switching element SW1 is in the OFF state. Then, it is assumed that a current indicated by a two-dot-chain line flows in the bridge circuit 12. However, in the path indicated by the two-dot-chain line, the voltage of the power supply BAT is applied, impedance is large due to the long path, and a current in an opposite direction, that is, a negative current hardly flows. For this reason, braking of the electric motor M is hardly applied. In a case where it is detected that the operation of the opening/closing body 30 is performed by the user, the drive mode is set to the second drive mode in which regenerative braking is not performed, whereby it is possible to avoid regenerative braking which acts in a direction of canceling a force of a closing operation or an opening operation of the user. The opening/closing operation of the user can be detected by detecting an operation pulse of the opening/closing body 30.

FIG. 4B is a control chart of the switching elements SW1 to SW4 in the second drive mode in a case where the duty ratio is 0.5. As described above, the switching element SW1 is subjected to PWM control and is repeatedly ON and OFF, and in order to suppress regenerative braking, the switching element SW3 is always OFF, the switching element SW2 for normal rotation is always OFF, and the switching element SW4 is always ON.

As described above, the opening/closing body control device 10 includes the bridge circuit 12 which includes the switching elements SW1 to SW4 connected to the electric motor M, and the control unit 11 which controls the on or off state of the switching elements SW1 to SW4, and the control unit 11 controls the on or off state of the switching elements SW1 to SW4 such that the bridge circuit 12 enters the regenerative state in a case where control for fully closing or fully opening the opening/closing body 30 is performed, and controls the on or off state of the switching elements SW1 to SW4 such that the bridge circuit 12 does not enter the regenerative state in a case where an operation of the opening/closing body 30 is performed by the user. The regenerative state refers to a state where the control unit 11 performs regenerative braking.

In this way, in a case where it is not detected that the operation of the opening/closing body 30 is performed by the user, driving control and regenerative braking control are performed, whereby control for opening or closing the opening/closing body is performed with high followability to the target speed, and in a case where it is detected that the operation of the opening/closing body 30 is performed by the user, regenerative braking is not performed, thereby avoiding regenerative braking which acts in a direction of canceling a force of a closing operation or an opening operation of the user. As a result, it is possible to provide an opening/closing body control device which optimizes driving control and regenerative braking control of the opening/closing body 30 according to whether or not the operation of the electric opening/closing body 30 is performed by the user, assists the closing operation or the opening operation of the user to improve user-friendliness, and achieves followability to the target speed of the opening/closing body and ease of an opening/closing operation by a person.

The above-described content may be regarded as an opening/closing body control method which controls the opening or closing of the opening/closing body 30 with the electric motor M. That is, this method is an opening/closing body control method which performs driving control and regenerative braking control in a case where control for fully closing or fully opening the opening/closing body 30 is performed, and inhibits regenerative braking control in a case where an operation of the opening/closing body 30 is performed by a person. With this configuration, it is possible to provide an opening/closing body control method which optimizes driving control and regenerative braking control of the opening/closing body 30 according to whether or not an operation of the electric opening/closing body 30 is performed by a person and improves user-friendliness.

A case where the control unit 11 performs control for fully closing or fully opening the opening/closing body 30 may be a case where the control unit 11 controls the speed for fully closing or fully opening the opening/closing body 30. That is, the control unit 11 may control the on or off state of the switching elements SW1 to SW4 such that the bridge circuit 12 does not enter the regenerative state while the speed is being controlled through PWM control in the course of fully closing or fully opening the opening/closing body 30. With this configuration, in a case where PWM driving control is performed, even in a case where an operation of the opening/closing body 30 is performed by a person, it is possible to further optimize driving control and regenerative braking control of the opening/closing body 30 and to improve user-friendliness.

The invention is not limited to the embodiments, and any configuration can be made without departing from the scope of the claims That is, in the invention, although the specific embodiments are mainly illustrated in the drawings and described, those skilled in the art can make various modifications in the number of components, application examples, and other detailed configurations to the embodiments described above without departing from the technical idea or the range of the invention.

For example, in the above-described example, although the opening/closing body, such as the door or the power tail gate of the vehicle, has been described as an example, the invention can be applied to an opening/closing body, such as a shutter in a building.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An opening/closing body control device which controls opening or closing of an opening/closing body with an electric motor, the opening/closing body control device comprising:
a bridge circuit which comprises a switching element connected to the electric motor; and
a control unit which controls an on or off state of the switching element,
wherein the control unit controls the on or off state of the switching element such that the bridge circuit enters a regenerative state in a case where control for fully closing or fully opening the opening/closing body is performed, and
wherein the control unit controls the on or off state of the switching element such that the bridge circuit does not enter the regenerative state in a case where an operation of the opening/closing body is performed by a person.

2. The opening/closing body control device according to claim 1,
wherein a case where the control unit performs the control for fully closing or fully opening the opening/closing body comprises a case where the control unit controls a speed for fully closing or fully opening the opening/closing body.

3. An opening/closing body control method which controls opening or closing of an opening/closing body with an electric motor, the opening/closing body control method comprising:
performing driving control and regenerative braking control in a case where control for fully closing or fully opening the opening/closing body is performed; and
inhibiting the regenerative braking control in a case where an operation of the opening/closing body is performed by a person.
